(19) United States
(12) Patent Application Publication
(10) Pub. No.: US 2008/0158425 A1
(43) Pub. Date: Jul. 3, 2008

(54) IMAGE PROCESSING APPARATUS AND METHOD

(75) Inventor: Tsuyoshi Kimura, Kawasaki (JP)

Correspondence Address: YOUNG & THOMPSON, 209 Madison Street, Suite 500, ALEXANDRIA, VA, 22314, US

(73) Assignee: NEC ELECTRONICS CORPORATION, KAWASAKI (JP)

(21) Appl. No.: 11/965,775

(22) Filed: Dec. 28, 2007

(30) Foreign Application Priority Data
Dec. 28, 2006 (JP) 2006-353626

(51) Int. Cl. H04N 9/74

(52) U.S. Cl. 348/586; 348/E09.055

(57) ABSTRACT

An OSD plane circuit reads one pixel at a time from OSD plane image data stored in a memory and outputs to a compositing unit. A background selecting unit, referring to background selecting data, selects the output of one of a first background data outputting unit and a second background data outputting unit, which output background data different in color, and outputs to the compositing unit, which composites data from the OSD plane circuit and data from the background selecting unit on a per pixel basis and outputs to the display unit. The background selecting data has a pixel corresponding to each pixel of the OSD plane image data, data of the pixel indicating either the first background data outputting unit or the second background data outputting unit.

### BACKGROUND OF THE INVENTION

1. Field of the Invention

The present invention relates to image processing and specifically to a technique of compositing front image data and background data.

2. Description of Related Art

With an image display apparatus that is applied to the OSD (On Screen Display) of televisions, operation is performed such as designating a target area on a displayed image from among multiple areas set beforehand by using an input device such as a touch pen or a mouse and, for example, scrolling the screen in the designated area or setting display items. In this case, in order to make which area has been designated easy to see, the designated area is preferably distinguished from the other area (hereinafter called a non-designated area) visually.

In Japanese Unexamined Patent Application Publication No. 2005-140871, a technique is disclosed where using the technique of a color palette, carat data (binary data) in the designated area or the non-designated area of display image data is inverted, thereby making the designated area and the non-designated area visually different from each other on the display screen.

In Japanese Unexamined Patent Application Publication No. 2002-6827 (hereinafter called reference 2), a technique is disclosed where, when compositing front image data and background data to display, by controlling the background color of an area according to whether it is a designated area or a non-designated area so as to make the background color of the designated area different from the background color of the non-designated area, the designated area is modified. This technique selectively uses one of two background colors depending on whether the area is a designated area or a non-designated area for a visual difference between the designated area and the non-designated area.

Also, a technique is known which changes the color of a designated area in a front image for a visual difference between the designated area and the non-designated area.

In the technique of the reference 2, because background color data is not image data, coordinates need to be calculated when outputting selected background color data. If the designated area is rectangular, the coordinates can be easily calculated, but if having a complicated shape, the calculation of the coordinates is also complicated. Hence, if the designated area is of a shape other than a rectangle, such as a rhombus or an irregular shape, or if not the whole but a part of the designated area is modified in background color, the coordinate calculation by hardware is difficult. Meanwhile, it takes substantial time to calculate the coordinates by a processor each time background color data is output and thus is not applicable to practice.

In the technique of changing the color of the designated area in the front image, directly editing the front image data to change the pixel values of corresponding pixels will cause the user to feel uncomfortable because the color changes pixel by pixel on the display screen as the editing proceeds.

The following technique is possible for changing the color of the designated area in the front image so as not to cause the user to feel uncomfortable. When changing the color of the designated area in the front image, front image data stored in memory is copied, and the copied front image data is edited to change data of pixels corresponding to the designated area of the front image. Then, the original front image data is replaced with the edited front image data.

However, this technique requires memory of a capacity to store two front image data. For example, since a high definition television (hereinafter called an HD) has a screen of 2 Megapixels, if the front image data is a total of 24 bpp (bit per pixel) of data for three channels of RGB or YCbCr, a memory capacity of 48 Megabits is required to store two front image data.

Further, in the field of compositing a background image and a front image to display, α-blending is known as the technique of producing various visual effects. In this technique, an α-value indicating a transmittance is attached to each pixel data of the front image, and front image data and background image data are composited on a per pixel basis in a ratio according to this α-value. For example, when the α-value indicates being “completely transmissive” that is a maximum value, the composite data is the background image data. Meanwhile, when the α-value indicates being “opaque” that is a minimum value, the composite data is the front image data. Because such front image data is of 32 bpp, a memory capacity of 64 Megabits is needed to store two front image data, thus increasing the necessary memory capacity.

### SUMMARY

According to one aspect of the present invention, there is provided an image processing apparatus that includes a compositing unit that composites data of each pixel of front image data and data of a corresponding pixel of background data to obtain a composite image data, a memory that stores background selecting data having a pixel corresponding to each pixel of the front image data, data of the pixel indicating one of a plurality of background data, and a background selecting unit that selects and supplies background data indicated by pixel data of the background selecting data stored in the memory to the compositing unit.

According to another aspect of the present invention, there is provided an image processing apparatus that includes a memory that stores a plurality of background selecting data, a control unit that selects one of the plurality of background selecting data based on a control signal, and a compositing unit that composites background data generated based on the selected background selecting data and front image data to obtain composite image data.

Implementation of the above aspects as a system or a program is also effective as another aspect of the present invention.

According to the image processing technique of the present invention, the designated area can be modified without causing a user to feel uncomfortable and the memory capacity can be saved.

### BRIEF DESCRIPTION OF THE DRAWINGS

The above and other objects, advantages and features of the present invention will be more apparent from description of certain preferred embodiments taken in conjunction with the accompanying, in which:

FIG. 1 shows a reproducing apparatus according to an embodiment of the present invention;

FIG. 2 shows scan order;

FIG. 3 shows an image of an OSD plane;

FIG. 4 shows an image displayed when background data of each pixel is the same;

FIG. 5 shows an example of edited background selecting data;

FIG. 6 shows a composite image obtained with the background selecting data shown in FIG. 5; and

FIG. 7 is a flow chart showing the process flow by the reproducing apparatus shown in FIG. 1.

### DETAILED DESCRIPTION OF THE PREFERRED EMBODIMENTS

The invention will now be described herein with reference to illustrative embodiments. Those skilled in the art will recognize that many alternative embodiments can be accomplished using the teachings of the present invention and that the invention is not limited to the embodiments illustrated for explanatory purposes.

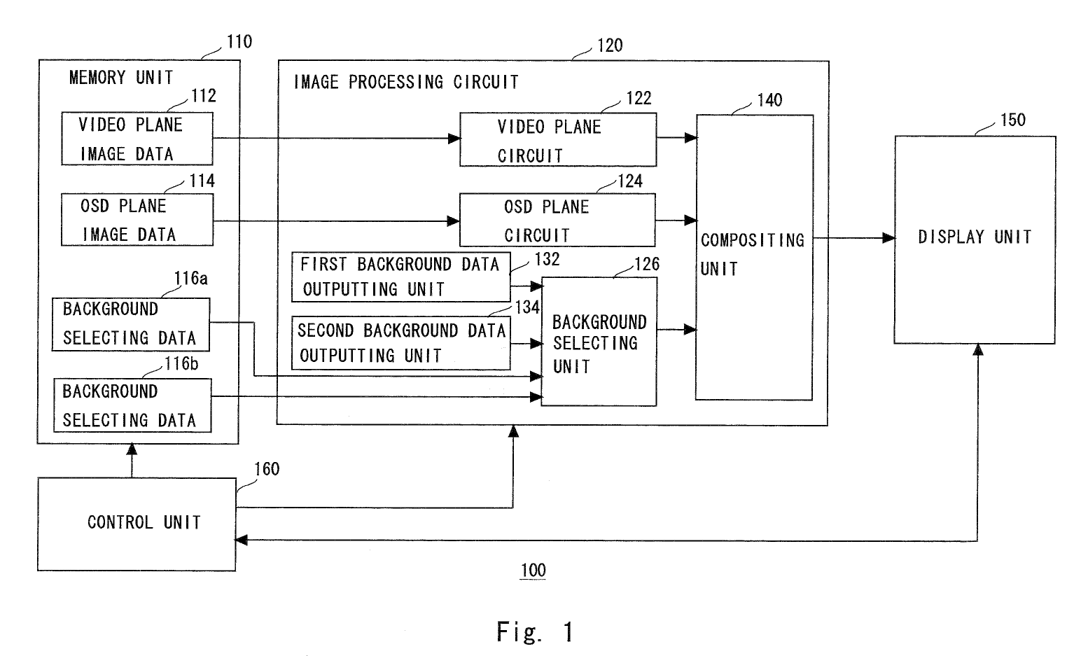

FIG. 1 shows a reproducing apparatus 100 according to the embodiment of the present invention. This reproducing apparatus is an image reproducing apparatus according to an HD scheme and comprises a memory unit 110, an image processing circuit 120, a display unit 150, and a control unit 160.

The memory unit 110 is, e.g., a RAM (Random Access Memory) and stores video plane image data 112, OSD plane image data 114, background selecting data 116a, and background selecting data 116b. These data each have 1,920×1,080 pixels (about 2 Megapixels) per screen according to the HD scheme.

The image processing circuit 120 comprises a video plane circuit 122, an OSD plane circuit 124, a background selecting unit 126, a first background data outputting unit 132, a second background data outputting unit 134, and a compositing unit 140.

The video plane circuit 122 reads the video plane image data 112 stored in the memory unit 110 pixel by pixel and outputs to the compositing unit 140. The OSD plane circuit 124 reads the OSD plane image data 114 stored in the memory unit 110 and outputs to the compositing unit 140. The first background data outputting unit 132 and the second background data outputting unit 134 each output background data of one pixel different in color. The background selecting unit 126 selects either the first background data outputting unit 132 or the second background data outputting unit 134 and supplies background data output from the selected background data outputting unit to the compositing unit 140.

The compositing unit 140 composes three pixel data supplied respectively from the video plane circuit 122, the OSD plane circuit 124, and the background selecting unit 126 into one pixel data, and outputs to the display unit 150. The compositing unit 140 composites them such that the OSD plane data is at the front and that the background data is at the furthest back.

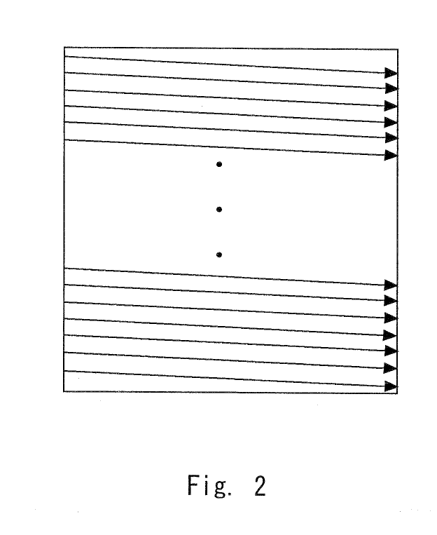

The compositing unit 140 outputs the composite data obtained in this way pixel by pixel in the order of from the left end to the right end along a scan as indicated by an arrow in FIG. 2, then from the left end to the right end of the next row. The composite data for the pixels from the top left end to the bottom right end is displayed as one screen of a television picture on the display screen of the display unit 150.

The display unit 150 displays the composite data output from the compositing unit 140. The reproducing apparatus 100 is provided with an input device (not shown) such as a remote controller, with which to perform various setting operations related to reproduction.

The control unit 160 is, for example, a CPU (Central Processing Unit) and controls the memory unit 110, the image processing circuit 120, and the display unit 150. To be specific, the control unit 160 performs processing such as editing data stored in the memory unit 110, controlling in supplying either the background selecting data 116a or the background selecting data 116b to the background selecting unit 126, and accepting an instruction from user via the input device (not shown) to have a corresponding function block of the image processing circuit 120 perform corresponding processing.

The video plane image data 112 is image data of one screen of a video sequence.

The OSD plane image data 114 is also image data and includes data of a pixel corresponding to each pixel of the video plane image data 112. To be specific, the OSD plane image data 114 is data of the contents of a caption or a menu for settings related to reproduction that is displayed on a video image.

The background selecting data 116a includes data of a pixel corresponding to each pixel of the video plane image data 112 or the OSD plane image data 114, and the data of the pixels indicate either the first background data outputting unit 132 or the second background data outputting unit 134. In this embodiment, because there are two background data outputting units, the background selecting data 116a is 1 bpp of data, and each pixel indicates the first background data outputting unit 132 by being, e.g., “0” or the second background data outputting unit 134 by being “1”.

In an initial state, the background selecting data 116b is the same as the background selecting data 116a.

The background selecting unit 126 selects the output of either the first background data outputting unit 132 or the second background data outputting unit 134, and supplies to the compositing unit 140. The selection is performed based on either the background selecting data 116a or the background selecting data 116b. The control unit 160 controls which of the two background selecting data is supplied to the background selecting unit 126.

The background selecting unit 126 selects either the first background data outputting unit 132 or the second background data outputting unit 134 according to whether pixel data of interest in the background selecting data being used is “0” or “1”.

Next, the reproducing apparatus 100 will be described in detail. To make the subject of the present invention easy to understand, the description of the operation in usual reproduction of the reproducing apparatus 100 will be omitted, and the operation of the reproducing apparatus 100 in setting in relation to reproduction, e.g., in selecting the title of a movie will be described, where the OSD plane data and background data are displayed. Note that whether the video plane data is to be displayed or not is a matter of design and that in this embodiment only the OSD plane data and background data are displayed.

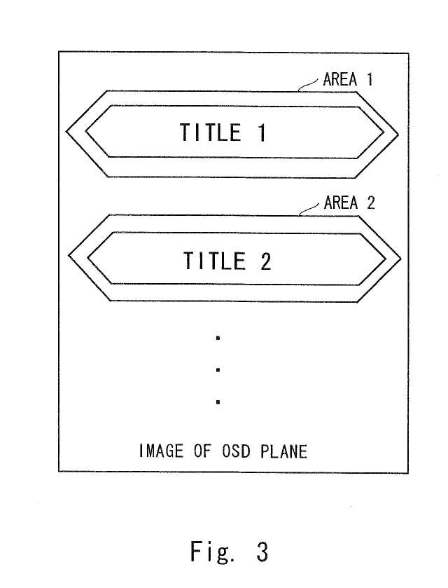

FIG. 3 is a schematic view of an image (hereinafter simply called an OSD plane) represented by the OSD plane data used to select a title. As shown in the Figure, the OSD plane includes areas such as an area 1 and an area 2 showing multiple titles such as a title 1 and a title 2. These areas are modification candidate areas to be modified when designated by the input device (not shown) and called title areas hereinafter. Each area is shaped in a rhombus and has an outer frame. These outer frames are modifiable parts that have their background color changed when the title areas are modified.

In the present embodiment, the OSD plane data, i.e., front image data and background data are composited using the α-blending technique, and an α-value indicating a transmittance is attached to each pixel of the OSD plane image data 114. Here, as to each title area in the OSD plane image data 114, the α-value of the pixels of the outer frame is set at “completely transmissive”, and the α-value of the pixels of the other part is set at “opaque”.

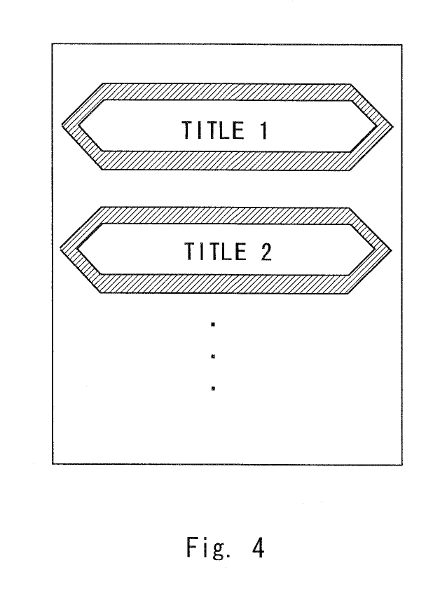

That is, if for all the pixels of the OSD plane shown in FIG. 3, the background selecting unit 126 selects the output of, e.g., the first background data outputting unit 132, the image shown in FIG. 4 is displayed on the display unit 150. Note that the first background data outputting unit 132 outputs a pixel value indicating a predetermined color such as blue and that hatching in the outer frames in the Figure means the color indicated by the pixel value output from the first background data outputting unit 132.

As described above, the background selecting unit 126 selects either the first background data outputting unit 132 or the second background data outputting unit 134 based on the background selecting data supplied. In order to have the image of FIG. 4 displayed, background selecting data whose pixels are at “0” indicating the first background data outputting unit 132 may be used. In the present embodiment, in an initial state, the pixels contained in either of the background selecting data 116a and 116b are at “0”, and initially, the control unit 160 controls the background selecting unit 126 to refer to the background selecting data 116a.

In the state where the image of FIG. 4 is displayed, when a title area, e.g., the area 1 is designated via the input device (not shown) of the reproducing apparatus 100, the control unit 160 edits the background selecting data 116b in order to modify the designated area 1. Because this editing is performed on the background selecting data 116b, the background selecting data 116a being used by the background selecting unit 126 does not change. Hence, the screen displayed on the display unit 150 remains as shown in FIG. 4.

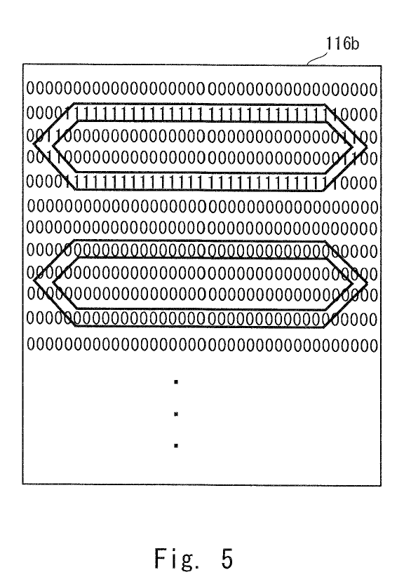

In the initial state, the background selecting data 116b is the same as the background selecting data 116a, where each pixel is at bitwise “0”. The control unit 160 changes all pixel data corresponding to the outer frame of the designated area, here the area 1, of the background selecting data 116b from “0”, indicating the first background data outputting unit 132, to “1”, indicating the second background data outputting unit 134. FIG. 5 shows the edited background selecting data 116b. As shown in the Figure, all pixel data corresponding to the outer frame of the designated area (the area 1) of the edited background selecting data 116b have been changed to “1”, indicating the second background data outputting unit 134.

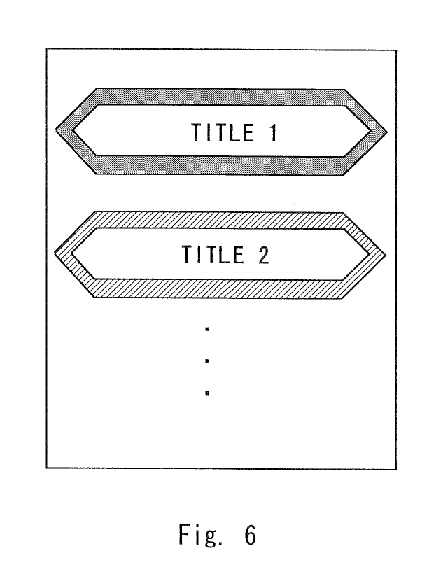

After editing the background selecting data 116b, the control unit 160 switches data which the background selecting unit 126 refers to from the background selecting data 116a to the edited background selecting data 116b. This switching is to change the address which the background selecting unit 126 refers to from the address of the background selecting data 116a to the address of the background selecting data 116b. By this means, the background selecting data which the background selecting unit 126 refers to is changed to data shown in FIG. 5. As a result, the screen shown in FIG. 6 is displayed on the display unit 150. As shown in the Figure, the color of the outer frame of the area 1 designated by the input device becomes different from that of the outer frames of the other title areas (a color, e.g. red, indicated by background data output from the second background data outputting unit 134). Thereby, the visual effect that the designated area is different from the other title areas is produced, so that the user understands which title he/she has selected.

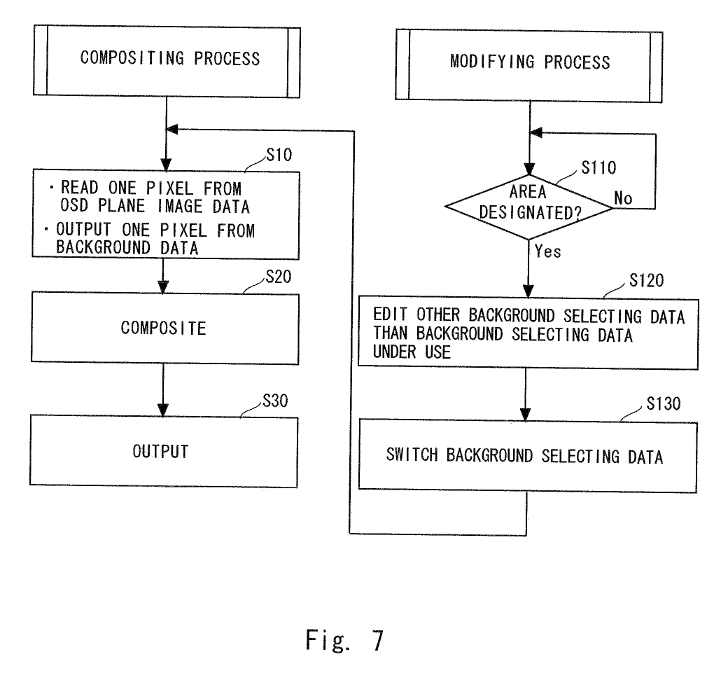

FIG. 7 is a flow chart showing the process flow by the reproducing apparatus 100 when selecting a title. The compositing process is performed by the image processing circuit 120, and the modifying process is performed by the control unit 160.

In compositing the OSD plane data and the background data, the OSD plane circuit 124 of the image processing circuit 120 reads one pixel from the OSD plane image data 114 stored in the memory unit 110 and outputs to the compositing unit 140. The background selecting unit 126, according to the control of the control unit 160, outputs the output of the first background data outputting unit 132 as background data to the compositing unit 140 based on one of the two background selecting data stored in the memory unit 110 (S10). In the initial state, the background selecting data 116a is used. The compositing unit 140 composites one pixel data from the OSD plane circuit 124 and one pixel data from the background selecting unit 126 based on the α-value attached to the pixel data from the OSD plane circuit 124 and outputs to the display unit 150 (S20, S30). The composite data is displayed by the display unit 150. Note that the processes of S10 through S30 are performed pixel by pixel in the scan order as shown in FIG. 2.

The modifying process by the control unit 160 is performed when a title area has been designated by the input device (S110: Yes). From among the two background selecting data stored in the memory unit 110, the control unit 160 edits the pixel data of the outer frame, a modifiable area, of the title area designated at step S110 of the other background selecting data than the one being used by the background selecting unit 126 so as to indicate the second background data outputting unit 134 (S120), and then switches the background selecting data which the background selecting unit 126 references to the edited data (S130). By this means, the background selecting unit 126 starts to select either the first background data outputting unit 132 or the second background data outputting unit 134 based on the edited, new background selecting data, so that the outer frame of the designated area becomes different in background color from the outer frames of the other title areas.

In the subsequent processes, each time the background of the composite image needs to be changed, the control unit 160 edits the background selecting data not being used by the background selecting unit 126 and switches the background selecting data supplied to the background selecting unit 126 to the edited background selecting data. For example, after the editing of background selecting data and the switching due to a title area being designated, when another title area is designated, the control unit 160 edits the background selecting data not being used by the background selecting unit 126 such that the outer frame of the newly-designated title area differs in background color from the outer frame of the other designated title area and switches the background selecting data to the edited one.

As such, according to the reproducing apparatus 100 of the present embodiment, when modifying a designated area, the background selecting data not being used by the background selecting unit 126 is edited, and the background selecting data which the background selecting unit 126 refers to is switched to the edited background selecting data. Hence, the visual difference between the designated area and the other areas is produced without causing a user to feel uncomfortable.

Since the pixels of the background selecting data 116 correspond respectively to the pixels of the OSD plane image data 114, coordinates need not be calculated. Thus, the load on the control unit 160 is light, and even if the shape of an area to be modified or a modifiable part is complicated, the invention can be implemented.

Further, because the background selecting data 116 of the present embodiment is 1 bpp of data, the total size is only about 2 Megabits in the case of the HD scheme. Hence, 2 Megabits is enough for memory capacity required when the background selecting data 116 is copied and edited, thus saving memory capacity.

The present invention has been described by way of an embodiment. The embodiment is illustrative, and various modifications and additions or subtractions may be made as long as not departing from the subject of the present invention. It is to be understood by those skilled in the art that variants made by the modifications and additions or subtractions fall within the scope of the present invention.

For example, although in the reproducing apparatus 100 the background data of the modifiable part of a designated area and the background data of the other areas are made different using two background data different in color, as long as a visual difference between the modifiable part of the designated area and the other areas is produced, the number of background data is not limited to two.

Further, although in the reproducing apparatus 100 the present invention is applied to the modification of an area designated by a user, not being limited to this, the invention can be applied to any apparatus that composites front image data and background data on a per pixel basis to display the composite image. For example, in order to give different visual effects to the displayed image as time elapses, transmittance information in pixel data of front image data corresponding to a part to be changed is set at “completely transmissive”, and background selecting data may be edited and switched to as time elapses.

Yet further, although in the reproducing apparatus 100 the first background data outputting unit 132 and the second background data outputting unit 134 each output background data different in color to make the modifiable part of a designated area different in color from the modifiable parts of the other areas, for example, similar colors different in brightness may be used as long as a visual difference between the modifiable part of the designated area and the modifiable parts of the other areas is produced.

Although in the reproducing apparatus 100 the transmittance of the modifiable part is set at “completely transmissive”, it may be set at any value other than “opaque” as long as the pixel value for color, brightness, or the like of background data of the modifiable part can be reflected in the composite image.

Although in the reproducing apparatus 100 two background selecting data are stored beforehand in memory, for example, in the initial state, only one background selecting data may be stored and when changing the background of a composite image, the background selecting data stored may be copied and the copied background selecting data may be edited and switched to. Thereafter, each time the background of a composite image is changed, switching between the already-existing two background selecting data may be performed.

Moreover, in the reproducing apparatus 100 the other background selecting data than the background selecting data being used by the background selecting unit 126 is edited according to the content of modification, and the edited background selecting data is switched to. By this means, background change can be dealt with using only the two background selecting data, thus saving memory capacity as much as possible. For example, respective background selecting data corresponding to the possible contents of modification may be stored beforehand, and background selecting data corresponding to the actual content of modification may be used.

To be specific, for the example of the OSD plane shown in FIG. 4, for example, background selecting data for when not modified, background selecting data for when the area of title 1 has been designated, and background selecting data for when the area of title 2 has been designated may be stored beforehand in the memory, and the control unit may switch such that the corresponding background selecting data is used in each case. For example, for the HD scheme, because the size of the front image data is about 32 Megabits, in order to store another front image data to change the background of a composite image, a memory capacity of 32 Megabits is needed. In contrast, because the size of the background selecting data is about 2 Megabits, if the number of background selecting data is at or below 15, memory capacity can be saved as compared with a method where the front image data is copied and edited.

It is apparent that the present invention is not limited to the above embodiments, but may be modified and changed without departing from the scope and spirit of the invention.

What is claimed is:

1. An image processing apparatus comprising:
a compositing unit that composites data of each pixel of front image data and data of a corresponding pixel of background data to obtain a composite image data;
a memory that stores background selecting data having a pixel corresponding to each pixel of the front image data, data of the pixel indicating one of a plurality of background data; and
a background selecting unit that selects and supplies background data indicated by pixel data of the background selecting data stored in the memory to the compositing unit.

2. The image processing apparatus according to claim 1, further comprising:
a control unit capable of changing a background of a composite image represented by the composite image data obtained from the compositing unit,
wherein the memory stores a plurality of background selecting data, and the background selecting unit performs the selection using one of the plurality of background selecting data, and
wherein the control unit switches the background selecting data that is supplied to the background selecting unit from background selecting data being used by the background selecting unit to another background selecting data, thereby changing the background of the composite image.

3. The image processing apparatus according to claim 2, wherein when changing the background of the composite image, the control unit edits the other background selecting data and performs the switching to the edited other background selecting data.

4. The image processing apparatus according to claim 3, further comprising:
a plurality of background data outputting units that respectively output the plurality of background data,
wherein the background selecting unit selects one of the plurality of background data outputting units, thereby selecting background data to be supplied to the compositing unit.

5. The image processing apparatus according to claim 3, wherein each pixel data of the front image data has transmittance information attached thereto, and the compositing unit composites the pixel data of the front image data and background data on a per pixel basis in a ratio according to the transmittance information.

6. The image processing apparatus according to claim 5, wherein the transmittance information of each of the pixels of the front image data corresponding to a modifiable part of one or more modification candidate areas in the composite image is set such that background image data is displayed in the modifiable part, and
wherein when one of the modification candidate areas in the composite image is determined to be an area to be modified, the control unit performs the switching or the switching after editing so that background data of the pixels corresponding to the modifiable part of the area to be modified becomes different from background data of the pixels corresponding to the modifiable part of the other modification candidate areas.

7. The image processing apparatus according to claim 6, wherein the modifiable part is an outer frame of the modification candidate area that it is part of.

8. An image processing method comprising:
a compositing step of compositing data of each pixel of front image data and data of a corresponding pixel of background data to obtain a composite image data; and
a background selecting step of, by using background selecting data having a pixel corresponding to each pixel of the front image data, data of the pixel indicating one of a plurality of background data, selecting and supplying background data indicated by pixel data of the background selecting data which corresponds to pixel data of interest of the front image data to the compositing step.

9. The image processing method according to claim 8, further comprising:
a control step of changing a background of a composite image represented by the composite image data,
wherein the control step switches the background selecting data that is supplied to the background selecting step between a plurality of background selecting data, thereby changing the background of the composite image.

10. The image processing method according to claim 9, wherein when changing the background of the composite image, the control step edits a background selecting data other than background selecting data being used by the background selecting step from among the plurality of background selecting data and performs the switching to the edited other background selecting data.

11. The image processing method according to claim 10, wherein the background selecting step selects one of a plurality of background data outputting units that respectively output the plurality of background data, thereby selecting background data to be supplied to the compositing step.

12. The image processing method according to claim 10, wherein each pixel data of the front image data has transmittance information attached thereto, and the compositing step composites the pixel data of the front image data and background data on a per pixel basis in a ratio according to the transmittance information.

13. The image processing method according to claim 12, wherein the transmittance information of each of the pixels of the front image data corresponding to a modifiable part of one or more modification candidate areas in the composite image is set such that background image data is displayed in the modifiable part, and
wherein when one of the modification candidate areas in the composite image is determined to be an area to be modified, the control step performs the switching or the switching after editing so that background data of the pixels corresponding to the modifiable part of the area to be modified becomes different from background data of the pixels corresponding to the modifiable part of the other modification candidate areas.

14. The image processing method according to claim 13, wherein the modifiable part is an outer frame of the modification candidate area that it is part of.

15. An image processing apparatus comprising:
a memory that stores a plurality of background selecting data;
a control unit that selects one of the plurality of background selecting data based on a control signal; and
a compositing unit that composites background data generated based on the selected background selecting data and front image data to obtain composite image data.

16. The image processing apparatus according to claim 15, further comprising:
a plurality of background data outputting units; and
a background selecting circuit to which outputs of the plurality of background data outputting units and the selected background selecting data are input, the background selecting circuit selecting corresponding data from the plurality of background data based on the selected background selecting data to output the selected data.

17. The image processing apparatus according to claim 16, wherein the plurality of background data outputting units include color information.

18. The image processing apparatus according to claim 15, wherein the background selecting data includes data to select the plurality of background data in a pixel unit corresponding to the composite image data.

19. The image processing apparatus according to claim 15, wherein the plurality of background selecting data includes first and second background selecting data, and the control unit selects one of the first and second background selecting data which is not selected when the control signal is input.

20. The image processing apparatus according to claim 15, wherein the control unit compiles one of the first and second background selecting data which is not selected when the control signal is input and selects the compiled background selecting data.
